(19) United States
(12) Patent Application Publication
(10) Pub. No.: US 2024/0109196 A1
(43) Pub. Date: Apr. 4, 2024

(54) Workstation and Operating Method Therefore

(71) Applicant: ABB Schweiz AG, Baden (CH)

(72) Inventors: Vaclav Švub, Nové Mesto na Morave (CZ); Ivo Kratochvil, Tabor (CZ); Jiri Hallman, Mala Skala (CZ); Tanja Vainio, Adliswil (CH)

(73) Assignee: ABB Schweiz AG, Baden (CH)

(21) Appl. No.: 18/524,271

(22) Filed: Nov. 30, 2023

Related U.S. Application Data
(63) Continuation of application No. PCT/EP2021/064515, filed on May 31, 2021.

(51) Int. Cl. B25J 9/16; G05B 19/18

(52) U.S. Cl. CPC B25J 9/1682; B25J 9/1697; G05B 19/182; G05B 2219/40583

(57) ABSTRACT

A robotic workstation comprises a source for workpieces having a region to be processed, a first robot having a processing tool, a second robot having a gripping tool for gripping a workpiece and placing it within an operating range of the first robot, a controller coordinating displacements of the robots and processing, an imaging system that identifies reference points of the gripping tool and the workpiece in an image, calculate a displacement vector between coordinates of the reference points, calculate a target position where the reference point of the gripping tool should be located, place the reference point of the gripping tool at a target position, and move the processing tool to the target location for processing the region to be processed.

### CROSS-REFERENCE TO RELATED APPLICATIONS

The instant application claims priority to International Patent Application No. PCT/EP2021/064515, filed May 31, 2021, which is incorporated herein in its entirety by reference.

### FIELD OF THE DISCLOSURE

The present invention relates to a workstation for automatized processing of workpieces and to a method for operating such a workstation.

### BACKGROUND OF THE INVENTION

A basic problem in automatized workpiece processing is that when a workpiece is seized by a general-purpose gripping tool, the position of the work-piece relative to the gripping tool may vary. The position of a tool for processing the workpiece or of a component that is to be joined to the work-piece must be controlled precisely, but open loop position control is difficult when a region of the workpiece that is to be processed is concealed by a tool that is used in the processing, or by a component, if the processing comprises joining said component to the workpiece.

According to U.S. Pat. No. 8,171,609 B2, the positioning problem can be solved by using a support or jig which defines a predetermined position for the workpiece and/or the component. If the position of the jig is precisely determined, and the workpiece is correctly mounted in the jig, the position of any part of the workpiece can be calculated. However, placing a workpiece precisely in the predetermined position defined by the jig tends to be time-consuming, and if the jig is to define positions of plural workpieces that are to be joined to each other in the relative positions in which they are held by the jig, specific jigs will be needed for different assembly jobs.

### BRIEF SUMMARY OF THE INVENTION

In a general aspect, the present disclosure describes a workstation and an operating method by which the inconveniences of a jig can be avoided. According to a first aspect of the invention, this object is achieved by a workstation comprising: a source for first workpieces, each first workpiece having a region to be processed, a first robot equipped with a processing tool for processing the region to be processed of the first workpiece; a second robot equipped with a gripping tool for gripping a first work-piece from the source and placing it within an operating range of the first robot; a controller adapted to coordinate displacements of the first and second robots and to control processing by the first robot; characterized in that the workstation further comprises an imaging system, and in that the controller is further adapted to:
a) identify reference points of the gripping tool and of the first workpiece in an image from the imaging system,
b) calculate a displacement vector between coordinates of the reference points of the gripping tool and of the first workpiece,
c) calculate, based on said displacement vector, a target position where the reference point of the gripping tool should be located in order to place the region to be processed of the first workpiece at a predetermined target location, or a target location where the region to be processed will be located when the reference point of the gripping tool is placed at a predetermined target position;
d) place the reference point of the gripping tool at said target position,
e) move the processing tool to the target location and processing the region to be processed.

### BRIEF DESCRIPTION OF THE SEVERAL VIEWS OF THE DRAWING(S)

FIG. 1 is an overall view of a workstation in an initial phase of an assembly process according to the disclosure.

FIG. 2 illustrates a phase of the method in which a first robot presents a workpiece to an imaging system for inspection in accordance with the disclosure.

FIG. 3 illustrates an image obtained by the imaging system in accordance with the disclosure.

FIG. 4 illustrates a phase in which a second robot presents a workpiece to an imaging system in accordance with the disclosure.

FIG. 5 illustrates a phase in which workpieces are approached to each other in accordance with the disclosure.

FIG. 6 illustrates a phase in which the workpieces are welded to each other in accordance with the disclosure.

FIG. 7 illustrates a phase in which the assembly obtained in the welding phase is presented to the imaging system in accordance with the disclosure.

FIG. 8 illustrates an image of the assembly obtained by the imaging system in accordance with the disclosure.

FIG. 9 is an enlarged view of the assembly and a further component being approached to it in accordance with the disclosure.

FIG. 10 is an enlarged view of the further component being welded to the assembly in accordance with the disclosure.

### DETAILED DESCRIPTION OF THE INVENTION

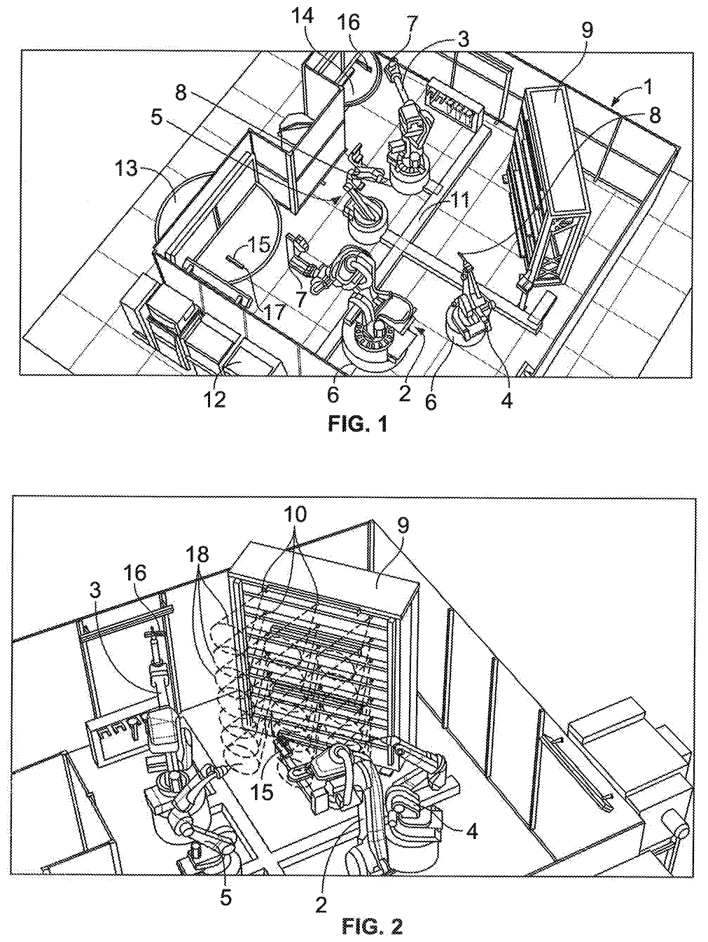

FIG. 1 is an overall view of a workstation according to the invention. Within a protective enclosure 1, four robots 2-5 are provided. In the present example, the robots 2-5 are articulated robots, each having a stationary base 6 attached to a workshop floor and an end effector 7, 8 connected to the base 6 by a plurality of links and movable with respect to the base 6 in several, preferably six or seven, degrees of freedom, but it will be readily apparent that the invention might also be implemented using robots having for base a movable trolley or the like.

A rack 9 is carrying a plurality of stationary cameras 10 (cf. also FIG. 2). The cameras 10 are mounted with their optical axes in parallel. Each camera 10 may comprise a telecentric lens, so that the size of an image of an object generated by the camera 10 will not depend on the distance between the lens and the object. Alternatively, the cameras 10 may have conventional lenses that produce an image of an object whose size is dependent on the distance between the lens and the object. In that case, optical axes of the cameras may be arranged in any way which ensures that an object located at a sufficient distance from the cameras 10 will be seen by more than one of the cameras 10, so that the distance of the object can be calculated by conventional triangulation techniques, and a real distance between two points of an object can be calculated from the distance between images of the points in a picture from one of cameras 10.

A floor-mounted cable duct 11 is connecting the robots 2-5 and the cameras 10 to a common controller 12.

End effectors of robots 2, 3 are gripping tools 7, designed to seize and manipulate workpieces. Here, turntables mounted in openings of the enclosure form sources 13, 14 for workpieces; fresh workpieces can be placed on a part of the turntables outside the enclosure, and by rotating the turntables 13, 14, the workpieces 15, 16 can be brought within reach of the robots 2, 3. Alternative possible sources might be a conveyor, an automated guided vehicle (AGV) or any container from which the gripping tools 7 are adapted to pick workpieces.

The robots 4, 5 have welding tools 8 for end effectors.

In the configuration of FIG. 1, under control of a manufacturing program executed by controller 12, robot 2 is approaching the elongate workpiece 15 on the turntable of source 13. The position of the workpiece 15 on the turntable is not specifically defined, and it may vary from one iteration of the assembly process to the next. Therefore, when the gripping tool 7 of robot 2 has seized the workpiece 15, the distance between a reference point of the workpiece, such as a tip 17 thereof, and a reference point of the gripping tool 7, such as a tool center point or a prominent geometric feature, is not known with the precision that would be necessary for subsequent welding of the workpiece 15.

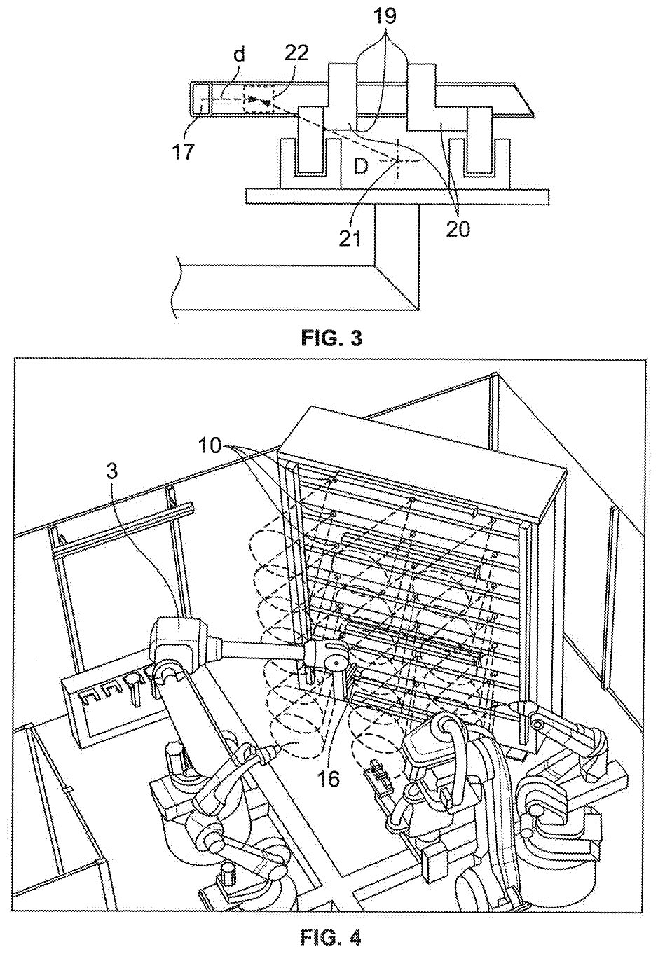

Therefore, while robot 3 is seizing workpiece 16 from source 14, robot 2 places workpiece 15 in front of the cameras 10, as shown in FIG. 2. Fields of view 18 of the cameras 10 are symbolized by cones, a base plane of which is perpendicular to the optical axes of the cameras 10. In the configuration shown in FIG. 2, a longitudinal axis of workpiece 15 is extending obliquely with respect to the base plane; when the robot 2 has aligned the longitudinal axis of the workpiece 15 with the base plane, the controller 12 obtains from the cameras 10 a picture as shown in FIG. 3. Here, the gripping tool 7 comprises two pairs of gripping jaws 20 which, when aligned, are displaceable in parallel to the optical axes of cameras 10 in order to pinch workpiece 15. In the picture, the controller identifies reference points of the gripping tool 7 and calculates from these the coordinates of a tool center point 21 in a co-ordinate system in which the workstation floor is stationary. This coordinate system, referred to here as the camera coordinate system, can be identical to a coordinate system, referred to here as the workstation coordinate system, that is used by the controller 12 for specifying and controlling movements of the robots 2-5, or can be related to it by a transformation which the controller 12 infers from coordinates and orientation of the gripping tool 7, which are available to it in the workshop coordinate system. In order to keep the description simple, it will be assumed that the camera and workshop coordinate systems are identical.

The reference points of the gripping tool 7 can be, e.g., prominent corners 19 of gripping jaws 20. Alternatively, they can be tokens designed to be easily recognizable in an image from the cameras 10 and which are deliberately applied to a surface of the gripping tool 7, e.g., by sticking, printing or engraving, so as to define a tool coordinate system which moves along with the tool 7. For the sake of convenience, it will be assumed here that the tool center point 21 is the origin of the tool coordinate system. Further, based on a reference point of the workpiece 15, e.g. at the tip 17, identified in the picture, and a displacement d, specified in the manufacturing program, be-tween the reference point 17 and a region 22 of the workpiece to be processed, e.g. welded, the controller 12 identifies the position of the region to be processed 22, identified in FIG. 3 by a dashed outline, and calculates a vector D that extends from the tool center point 21 to the region to be processed 22.

The manufacturing program specifies a location where the region to be processed 22 is to be placed in the workstation coordinate system of the. A corresponding target position for the tool center point 21 is obtained by subtracting the vector D from the target location of the region to be processed 22.

While robot 2 is moving its tool center point 21 to this tool center point target position, robot 3 presents to cameras 10 the workpiece 16 taken from source 14, as shown in FIG. 4. Similar to the vector D, a vector connecting the tool center point 15 of robot 3 and a joining region 23 (cf. FIG. 8) is obtained from a picture of the workpiece 16 held by the gripping tool 7 of robot 3. Based on this vector, a target position for the tool center point of robot 3 is calculated such that when the tool center point of robot 3 is at said target position, the joining region 23 will face the region to be processed 22 closely enough to allow welding of the two.

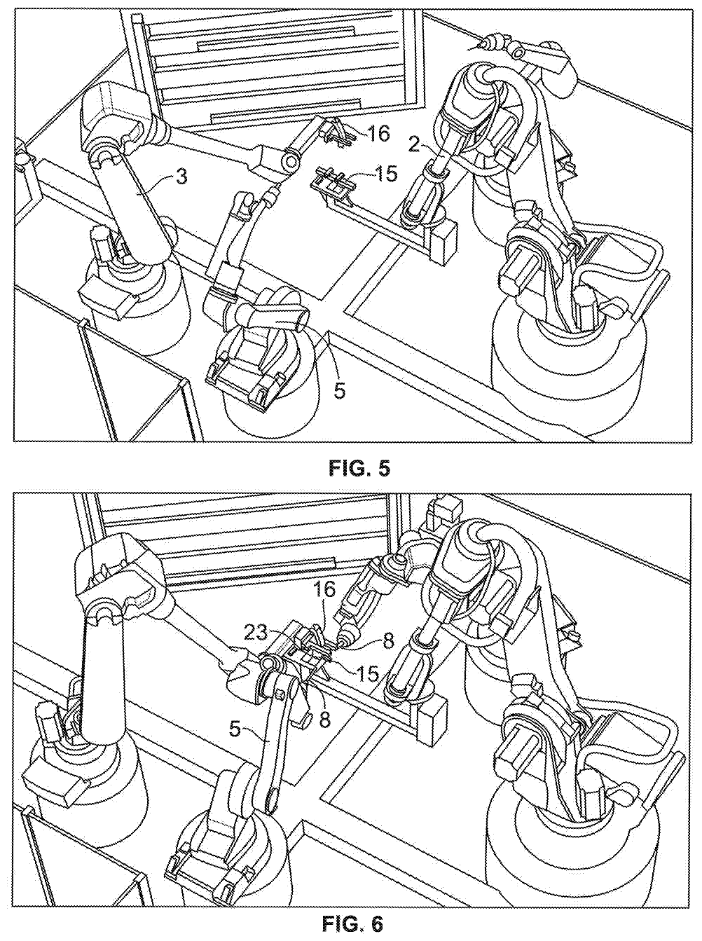

FIG. 5 shows the robot 3 in the process of approaching workpiece 16, from above, to workpiece 15 held by robot 2. In this example, workpiece 16 is a U-profile with two sidewalls connected by a central portion, and in which part of the central portion of the profile is cut out at the lower end of the pro-file, so that the two sidewalls form downwardly projecting tabs which, in the target position, will cover regions to be processed 22 on both side of workpiece 15. Each tab thus constitutes a joining region 23 (as can be seen in more detail in FIGS. 8 to 10).

In FIG. 6, both workpieces 15, 16 have reached their respective target positions, with workpiece 16 straddling workpiece 15. Welding tools 8 carried by robots 4, 5 have been placed at the outer sides of the joining regions 23 in order to weld these to the regions 22 of workpiece 15 and thus combine the workpieces into assembly 24.

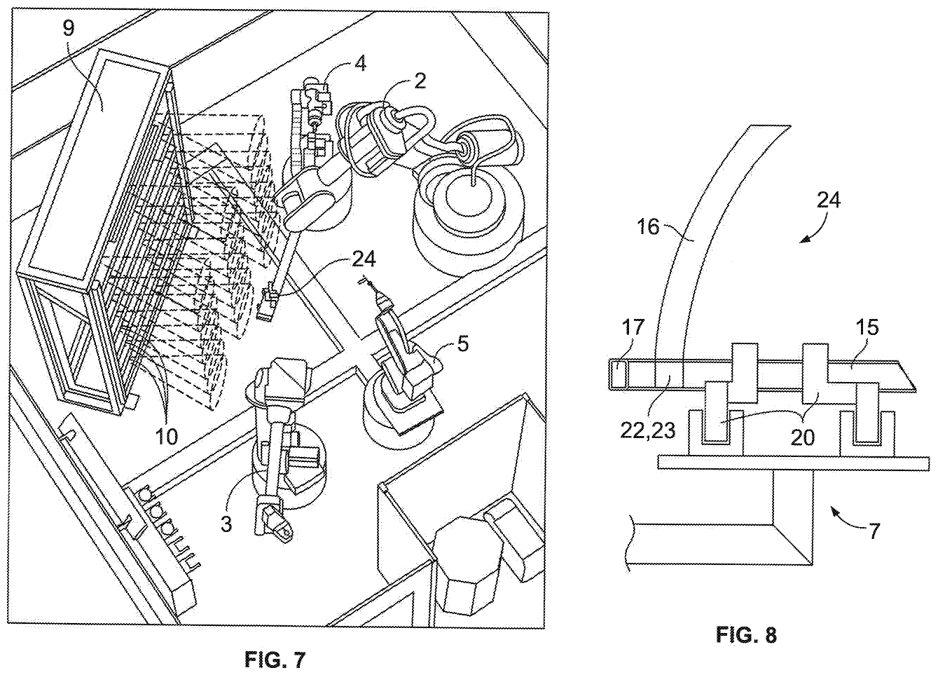

When the welding has been carried out, robot 3 releases workpiece 16 and moves to source 14 in order to fetch the next workpiece. Meanwhile, robot 2 presents the assembly 24 to the cameras 10 as shown in FIG. 7. FIG. 8 schematically illustrates an image which, at this occasion, is supplied to con-troller 12. Based on the image, controller 12 judges whether workpiece 16 has been mounted correctly and continues the assembly process only in the affirmative. It identifies a next region to be processed 25, e.g., opposite to tip 17 of workpiece 15.

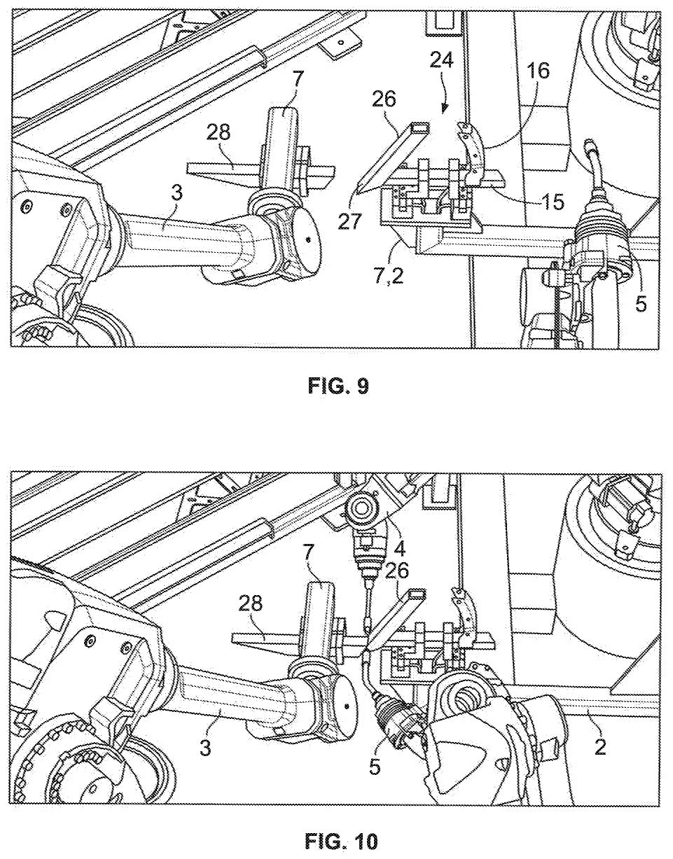

In FIG. 9, the workpiece fetched by robot 3 in the phase of FIG. 7, assigned reference numeral 26, has been added to assembly 24 by welding it to region 25, and robot 3 is placing a further workpiece 28 facing a region 27 at the lower end of workpiece 26.

FIG. 10 shows the robots 4, 5 in the process of welding workpiece 28 to region 27.

It is readily apparent that the assembly 24 and the workpieces from which it is assembled is not in itself relevant for the invention, but merely serves as a background for the description of the operation of the robots 2-5. Obviously, the above procedure may be repeated with as many workpieces as necessary to obtain a complete assembly, and that in any of these repetitions the robot which releases the assembly 24 and fetches the next workpiece might be robot 2 as well as robot 3, or that more than two robots might be used at one time to hold any number of workpieces that are to be connected to one another in one connecting, e.g. welding, process.

Further, the processing carried out at the region to be processed doesn't necessarily have to be the installation of another workpiece but might as well be some local treatment such as drilling, machining, laser engraving, or applying a surface layer such as paint, primer, adhesive etc.

### REFERENCE NUMERALS

1 enclosure
2 robot
3 robot
4 robot
5 robot
6 base
7 end effector (gripping tool)
8 end effector (welding tool)
9 rack
10 camera
11 cable duct
12 controller
13 source
14 source
15 workpiece
16 workpiece
17 tip
18 field of view
19 corner
20 gripping jaw
21 tool center point
22 region to be processed
23 joining region
24 assembly
25 region to be processed
26 workpiece
27 region to be processed
28 workpiece

The terms “image” and “imaging system” should be construed broadly here. I.e. any spatially resolved representation of the gripping tool and its environment from which coordinates of specific points can be inferred can serve as an image in the context of the present invention, and an imaging system can be any source of such images, e.g. one or several photographic cameras, laser scanners, radar sensors and the like.

By obtaining the image and determining from it the position of the first workpiece with respect to the gripping tool, it is possible to tell where the region to be processed will be located when the position of the tool reference point is known. The position of the tool reference point can be determined at any time using data from position sensors of the robot. Thus, the region to be processed can be placed reproducibly at a given target location if, based on said target location a target position for the reference point of the gripping tool is calculated, and the reference point is then steered to the target position. Alternatively, when the reference point is steered to a predetermined target position, target locations of the region to be processed may vary, but since they are known, the processing tool may still be steered there precisely.

When the processing of the first workpiece comprises joining its region to be processed to a second workpiece, a third robot may be provided that is equipped with a gripping tool for gripping a second workpiece and placing it within an operating range of the first robot.

Since the gripping tool of the third robot also has the problem that the relative position in which it seizes the second workpiece may vary, a processing similar to that of the first workpiece may be applied to it, wherein: a′) reference points of the gripping tool of the third robot and of the second workpiece are identified in an image from the imaging system, b′) a vector difference is calculated between coordinates of the reference points of the gripping tool and of the second workpiece, c′) based on said vector difference, a target position is calculated where the reference point of the gripping tool of the third robot should be located in order to place the joining region of the second workpiece facing the region to be processed; d) the reference point of the gripping tool of the third robot is placed at said target position.

Since the gripping tool of the second and, if present, the third robots are mobile, the imaging system may be stationary, and the robots may be used for placing the first or second workpiece within a field of view of the imaging system. This should be done after gripping the first (or second) workpiece from the source and before placing the reference point of the gripping tool at the target position.

The controller may be adapted to place the first workpiece within the field of view of the imaging system so that a line extending from the reference point of the first workpiece to the reference point of the gripping tool is perpendicular to an optical axis of the imaging system. Thus, the distance between the reference points can be extracted straightforwardly without having to take account of perspective effects.

Extraction of distance data is further facilitated if the imaging system comprises at least one camera with a telecentric lens.

Providing an array of cameras in the imaging system may increase the processing speed of the workstation, since detours the robot might have to go between the source and the target position in order to “show” the workpiece to the imaging system can be minimized by showing it to the camera that is most conveniently placed.

The controller may further be adapted to control placing at least the first workpiece within a field of view of the imaging system after the processing has been carried out. An image thus obtained can be used for judging whether the processing has been carried out correctly.

The processing tool may be a welding tool.

According to a second aspect of the invention, this object is achieved by a method of processing workpieces, comprising the steps of: a) gripping a first workpiece from a source using a second robot equipped with a gripping tool; then b) placing the first workpiece within the field of view of an imaging system by means of said second robot; c) identifying, in an image from said imaging system, a displacement vector between reference points of the gripping tool and of the first workpiece; d) calculating, based on said displacement vector, a target position where the reference point of the gripping tool should be located in order to place the region to be processed of the first workpiece at a predetermined target location, or a target location where the region to be processed will be located when the reference point of the gripping tool is placed at a predetermined target position; e) placing the reference point of the gripping tool at said target position, f) moving the processing tool to the target location and g) processing the region to be processed.

Step g) of processing the region to be processed may comprise joining to it a joining region of a second workpiece held by a third robot.

Assemblies comprising several workpieces can be formed by the further steps of l) one of said second or third robots releasing the workpiece held by it, m) gripping a third workpiece using said one robot, placing the third workpiece facing one of said first and second workpieces and joining the third workpiece to the first and second ones.

Further features and advantages of the invention will become apparent from the subsequent description of embodiments, referring to the appended drawings.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention, and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A workstation, comprising:
a source for first workpieces, each first workpiece having a region to be processed,
a first robot equipped with a processing tool for processing the region to be processed of the first workpiece;
a second robot equipped with a gripping tool for gripping a first workpiece from the source and placing it within an operating range of the first robot;
a controller adapted to coordinate displacements of the first and second robots and to control processing by the first robot;
wherein the workstation further comprises an imaging system, and in that the controller is further adapted to:
a) identify reference points of the gripping tool and of the first workpiece in an image from the imaging system,
b) calculate a displacement vector between coordinates of the reference points of the gripping tool and of the first workpiece,
c) calculate, based on said displacement vector, a target position where the reference point of the gripping tool should be located in order to place the region to be processed of the first workpiece at a predetermined target location, or a target location where the region to be processed will be located when the reference point of the gripping tool is placed at a predetermined target position;
d) place the reference point of the gripping tool at said target position,
e) move the processing tool (8) to the target location for processing the region to be processed.

2. The workstation of claim 1, further comprising a third robot equipped with a gripping tool for gripping a second workpiece and placing it within an operating range of the first robot; wherein processing comprises joining a joining region of the second workpiece to the region to be processed.

3. The workstation of claim 2, wherein the controller is further adapted to coordinate displacements of the third robot with the first and second robots, and to:
identify reference points of the gripping tool of the third robot and of the second workpiece in an image from the imaging system,
calculate a vector difference between coordinates of the reference points of the gripping tool and of the second workpiece,
calculate, based on said vector difference, a target position where the reference point of the gripping tool of the third robot should be located in order to place the joining region of the second workpiece facing the region to be processed;
place the reference point of the gripping tool of the third robot at said target position.

4. The workstation of claim 1, wherein the imaging system is stationary, and the controller is adapted to have at least the second robot place the first workpiece within a field of view of the imaging system after gripping it from the source and before placing the reference point of the gripping tool of the second robot at the target position.

5. The workstation of claim 1, wherein the controller is adapted to place the first workpiece within a field of view of the imaging system so that a line extending from the reference point of the first workpiece to the reference point of the gripping tool of the second robot is perpendicular to an optical axis of the imaging system.

6. The workstation of claim 1, wherein the imaging system comprises at least one camera having a telecentric lens and/or an array of cameras.

7. The workstation of claim 1, wherein the controller is adapted to control placing at least the first workpiece within a field of view of the imaging system after the processing has been carried out.

8. The workstation of claim 1, wherein the processing tool is a welding tool.

9. A method for processing workpieces, comprising:
gripping a first workpiece from a source using a second robot equipped with a gripping tool;
using the second robot to place the first workpiece within a field of view of an imaging system;
identifying, in an image from the imaging system, a displacement vector between reference points of the gripping tool and of the first workpiece;
calculating, based on the displacement vector, a target position where the reference point of the gripping tool should be located in order to place the region to be processed of the first workpiece at a predetermined target location, or a target location where the region to be processed will be located when the reference point of the gripping tool is placed at a predetermined target position;
placing the reference point of the gripping tool at said target position,
moving the processing tool to the target location, and
processing the region to be processed.

10. The method of claim 9, further comprising:
placing the first workpiece within the field of view of the imaging system; and
judging a quality of processing based on an image of the region after processing.

11. The method of claim 10, wherein processing the region to be processed comprises joining to the region to be processed a joining region of a second workpiece held by a third robot.

12. The method of claim 11, further comprising:
identifying, in an image from the imaging system, a displacement vector between reference points of a gripping tool of the third robot and of the second workpiece;
calculating, based on said displacement vector, a target position where the reference point of the gripping tool of the third robot should be located in order to place the joining region facing the region to be processed.

13. The method of claim 12 further comprising:
one of said second or third robots releasing the workpiece,
gripping a third workpiece using said one of said second or third robots, and
placing the third workpiece facing one of said first and second workpieces and joining the third workpiece to the first and second ones.
